(19) United States
(12) Patent Application Publication
(10) Pub. No.: US 2021/0403605 A1
(43) Pub. Date: Dec. 30, 2021

(54) PROCESS FOR PRODUCING PHYSICALLY MODIFIED STARCH BASED PRODUCTS DERIVED FROM GRAIN AND NON-GRAIN NATURAL FEEDSTOCKS

(71) Applicant: Archer Daniels Midland Company, Decatur, IL (US)

(72) Inventors: Baljit Ghotra, Champaign, IL (US); Ali Halalipour, Decatur, IL (US); Eric Marion, Mt. Zion, IL (US); Alexandra Sanborn, Lincoln, IL (US); Lijia Zhu, Forsyth, IL (US)

(21) Appl. No.: 17/287,891

(22) PCT Filed: Oct. 24, 2019
(86) PCT No.: PCT/US19/57967

§ 371 Date: Apr. 22, 2021

Related U.S. Application Data
(60) Provisional application No. 62/750,322, filed on Oct. 25, 2018.

(51) Int. Cl. C08B 30/12; A23L 29/212

(52) U.S. Cl. CPC C08B 30/12; A23L 29/212

(57) ABSTRACT

Disclosed herein are processing methods for producing a physically modified starch and for producing a physically modified flour and/or starch flour mixture. The starch process comprises adding at least one salt or additive to a starch, adjusting the pH of the starch to alkaline, and dewatering the starch using a filter to obtain filtered solids. The process further comprises drying the filtered solids, spreading a layer of dried filtered solids on a surface, and heating the dried filtered solids while on the surface to a temperature of about 100° C. to 190° C. to obtain the physically modified starch. In an embodiment, the flour and/or starch/flour mixture process comprises preparing a thermally inhibited flours and/or starch/flour mixtures starting with or without additives, pH adjustment, followed by heat treating the flour and/or starch/flour mixtures directly to obtain the physically modified flour and/or starch flour mixture.

### TECHNICAL FIELD

The present invention relates to processes for producing physically modified starch, physically modified flour and/or starch/flour mixtures-based products derived from grain and non-grain feedstocks.

### BACKGROUND

Amylose containing starches, such as dent corn starch, pea starch, high amylose starch hybrids from corn, rice or peas, or other amylose rich starches, have shown limited acceptability as a food thickener in food and beverage applications mainly due to inherent instability of amylose fractions in aqueous solutions or gel systems. This leads to undesirable product textural attributes during storage.

U.S. Pat. No. 3,977,897 discloses a method for preparing a non-chemically inhibited amylose-containing starch by controlled heating at a specified pH of an aqueous suspension of an amylose-containing starch in intact granule form and in inorganic salt effective in raising the gelatinization temperature of the starch. According to the patent, the temperatures useful in the disclosed process range from 50°-100° C., preferably 60°-90° C., for about 0.5 to 30 hours, while the pH of the aqueous suspension is maintained at a pH of 3.0 to 9.0, preferably 4 to 7. The patent states that highly alkaline systems, i.e., pH levels above 9, retard the inhibition reaction. The patent discloses that maintenance of the proper pH range is usually assured by adjusting the pH to about 5.0 to 6.0 before heating, and that buffers can also be used to maintain the pH at an appropriate level but in most cases no adjustment of pH is necessary.

U.S. Pat. No. 5,871,756 discloses cosmetics containing thermally inhibited starches and flours. The starch or flour is inhibited by dehydrating the starch or flour to anhydrous or substantially anhydrous and then heat treating the dehydrated starch or flour for a time and at a temperature sufficient to inhibit the starch or flour and improve its viscosity stability when dispersed in water. The dehydration may be a thermal or a non-thermal dehydration (e.g., by alcohol extraction or freeze-drying). Preferably, the pH of the starch or flour is adjusted to a neutral or above (e.g., pH 8-9.5) prior to the dehydration and heat treatment.

U.S. Pat. No. 5,725,676 discloses a process for preparing thermally inhibited starches and flours comprising dehydrating and heat treating a granular starch or flour. The patent discloses that preferably the process comprises the steps of raising the pH of the starch to neutral or greater, dehydrating the starch to anhydrous or substantially anhydrous, and heat treating the anhydrous or substantially anhydrous starch at a temperature of 100° C. or greater for a period of time effective to provide the inhibited starch.

JPS61254602 A discloses a process for preparing a modified starch. According to the disclosure, when carrying out heat treatment with a dry system, the moisture content of the waxy starch and/or the waxy starch derivative should be 10% or less, preferably 5% or less. If the moisture content is 10% or more, the starch partially gelatinizes or solidifies. When carrying out heat treatment in a wet manner, the concentration is 5 to 50%, preferably 20 to 30%. The pH range is 3.5 to 8.0.

U.S. Pat. No. 5,830,884 discloses starches and flours are inhibited by dehydrating the starch or flour to substantially anhydrous or anhydrous and then heat treating the anhydrous or substantially anhydrous starch or flour for a time and at a temperature sufficient to inhibit the starch or flour. The dehydration can be carried out by heating the starch or flour, by extracting the starch or flour with a solvent, or by freeze drying. Preferably, the pH is adjusted to a neutral pH or above prior to the dehydration and heat treatment.

U.S. Pat. No. 5,641,349 discloses starches or flours are thermally inhibited by dehydrating the starch to anhydrous or substantially anhydrous and then heat-treating the starch or flour for a time and at a temperature sufficient to inhibit the starch and improve its viscosity stability. The starch or flour may be thermally or non-thermally dehydrated (e.g., by alcohol extraction or freeze-drying). Preferably, the pH of the starch is adjusted to at least a neutral pH prior to the dehydration.

WO 1996023104 A1 discloses thermally inhibited starches and flours, preferably cationic or amphoteric starches which are optionally chemically cross-linked, and are added, primarily as wet end additives, to paper stock. The starch or flour is inhibited by dehydrating to anhydrous or substantially anhydrous and then heat treating the dehydrated starch or flour for a time and at a temperature sufficient to inhibit the starch or flour and improve its viscosity stability when dispersed in water. The dehydration may be a thermal or non-thermal dehydration (e.g., by alcohol extraction or freeze-drying). Preferably, the pH of the starch or flour is adjusted to neutral or above prior to dehydration.

There remains a need in the art for alternative processes for producing physically modified starch-based products derived from grain feedstocks, e.g., corn feedstocks (such as waxy corn and regular corn feedstocks), wheat feedstocks (such as waxy, high-amylose wheat feedstocks), rice feedstocks, and barley feedstocks, and non-grain natural feedstocks (e.g., feedstocks derived from botanical plants, such as tapioca, potato, pea, bean, and lentil), or a combination(s) thereof.

### SUMMARY

In each of its various embodiments, the present invention fulfills the need for more efficient production of a physically modified starch-based product derived from grain and non-grain natural feedstocks. In an aspect, a process for producing a physically modified starch comprises mixing starch with water to form a starch and water mixture. The process comprises adding at least one solute (also referred to as a salt or additive) to the starch and water mixture and adjusting the pH of the mixture to an alkaline pH of at least about 8. The process comprises dewatering the mixture using a filter and collecting the filtered solids. The process comprises drying the filtered solids by spreading a layer of filtered solids on a surface and heating the filtered solids while on the surface to a temperature of about 100° C. to 190° C., thus producing the physically modified starch.

In an aspect, a process for producing a physically modified starch comprises mixing starch having a starting percent moisture with water; adding at least one solute to the starch and water mixture, wherein the at least one solute is selected from the group consisting of sodium sulfate, sodium chloride, potassium iodide, and trehalose, and combinations thereof. The process comprises adjusting the pH of the mixture to a pH between about 8-10. The process comprises dewatering the mixture using a filter and collecting the filtered solids. In an embodiment, the process comprises drying the filtered solids so that the filtered solids have a percent moisture within 10% of the starting percent moisture of the starch. The process comprises spreading a layer of dried filtered solids on a surface and heating the dried filtered solids while on the surface to a temperature of about 100° C. to 190° C., thus producing the physically modified starch.

In an aspect, a process for producing a physically modified starch comprises adding at least one additive slurry to a starch in dry powder form, wherein the additive is selected from the group consisting of sodium sulfate, sodium chloride, potassium chloride, potassium iodide, and trehalose, and combinations thereof. The process comprises adjusting the pH of the starch in dry powder form to about 8-10 either prior to, simultaneous with, or after adding the additive slurry. The process comprises spreading a layer of dried filtered solids on a surface. The process comprises heating the dried filtered solids while on the surface to a temperature of about 100° C. to 190° C. to obtain the physically modified starch.

In an aspect, a process for producing a physically modified flour or starch/flour mixture comprises (1) spreading a layer of material on a surface, the material having an as-is moisture content and selected from the group consisting of a flour or flour/starch mixture; and (2) heating the material at a temperature in the range of 100−190° C. for a period of at least 1 hour, wherein a physically modified flour or starch/flour mixture is produced without additive, dehydration or pH adjustment of the material.

In an aspect, a composition comprises a food product and a thickener, the thickener comprising a physically modified starch, a physically modified flour, or a starch/flour mixture obtained in accordance with the processes disclosed herein.

In an aspect, the physically modified starch is characterized by viscosity stability when solubilized in excess water. In an aspect, the processes disclosed herein result in production of a thickener having improved viscosity stability at ambient, refrigerated and freezer storage temperatures.

In an aspect, the processes disclosed herein provide improved inhibited swelling of starch when heated in water.

In an aspect, the processes disclosed herein produce a starch product having better color and stronger or more robust starch granules for better processing tolerances than conventional processes.

These and other aspects, embodiments, and associated advantages will become apparent from the following Detailed Description.

### BRIEF DESCRIPTION OF THE DRAWINGS

FIGS. 1-5 are RVA graphs showing inhibited granular e ng in accordance with aspects of the invention.

### DETAILED DESCRIPTION

This invention discloses a process of making physically modified starch-based products and the use thereof. The process uses dry starch as starting material that is pH adjusted and impregnated with a solute, such as a salt, that binds water due to higher solubility in aqueous water. Benefits of using a solute, such as a salt, allows for physically modified starches and starch-based products to be fine-tuned to achieve desired viscosity and color characteristics not readily obtained in processes that do not use a solute, such as a salt. In an embodiment, the solute may be selected from the group consisting of sodium sulfate and sodium chloride, and combinations thereof. The new methods of producing inhibited starches may be applied to both grain and non-grain natural feedstocks, including feedstocks comprising waxy starch types and amylose-containing starches.

In each of its various embodiments, the present invention fulfills the need for more efficient production of a physically modified starch-based product derived from grain and non-grain natural feedstocks. In an aspect, a process for producing a physically modified starch comprises mixing starch with water, adding at least one soluble salt to the starch and water mixture, and adjusting the pH of the mixture to alkaline pH of at least 8. The process may comprise dewatering the mixture using a filter; collecting the filtered solids; drying the filtered solids; spreading a layer of dried filtered solids on a surface (e.g., a flat surface defined by a tray, a plate, a belt, or the inside of a vessel, such as a beaker); and heating the dried filtered solids while on the surface to a temperature of about 100° C. to 190° C. for at least 15 minutes, thus producing the physically modified starch.

In an aspect, a process for producing a physically modified starch comprises mixing starch having a starting percent moisture in the range of ˜1% to 30% by weight with water and adding at least one salt to the starch and water mixture, the at least one salt selected from the group consisting of sodium sulfate, sodium chloride, and combinations thereof. The process comprises adjusting the pH of the mixture slurry to a pH between 8-10, dewatering the mixture using a filter, and collecting the filtered solids. The process comprises drying the filtered solids so that the filtered solids have a percent moisture within 10% of the starting percent moisture of the starch. The process comprises spreading a layer of dried filtered solids on a surface and heating the dried filtered solids while on the surface to a temperature of about 100° C. to 190° C. for 15 minutes to 240 minutes, thus producing the physically modified starch.

In an embodiment, the at least one soluble salt may be added to the starch and water mixture before the adjusting of the pH, thereby impregnating the starch with the salt solute, followed by recovering dried starch solids, and then mixing the dry starch with an alkali solution to adjust the pH to at least 8.

In an embodiment, an alkali may be added to the starch and water mixture to adjust the pH to at least 8, thereby impregnating the starch with alkali, followed by recovering dried starch solids, and then mixing the dry starch with the at least one soluble salt.

In an aspect, a composition comprises a food product and a thickener, the thickener comprising a physically modified starch, the physically modified starch obtained by the method comprising mixing non-physically modified starch with water and adding at least one salt to the non-physically modified starch and water mixture. The process comprises adjusting the pH of the mixture to at least 8, dewatering the mixture using a filter, and collecting the filtered solids. The process comprises drying the filtered solids, spreading a layer of dried filtered solids on a surface, and heating the dried filtered solids while on the surface to a temperature of about 100° C. to 190° C. for at least 15 minutes, thus producing the physically modified starch. In an embodiment, the physically modified starch is characterized by viscosity stability when solubilized in excess water.

In an aspect, the physically modified starch is characterized by viscosity stability when solubilized in excess water.

In an aspect, the processes disclosed herein provide improved inhibited swelling of starch when heated in water.

In an aspect, the processes disclosed herein result in production of a unique thickener having viscosity stability at ambient, refrigerated and freezer storage temperatures.

In an aspect, the processes disclosed herein produce a starch product having better color and stronger or more robust starch granules for better processing tolerances than conventional processes.

The methods disclosed herein provide a breakthrough discovery in stabilization of amylose containing starches. The methods disclosed herein allows for amylose-containing starches for the production of inhibited starches. Amylose containing starches, e.g., dent corn starch, pea starch, high amylose starch hybrids from corn, rice or peas, or other amylose rich starches, have shown limited acceptability as a food thickener in food and beverage applications mainly due to inherent instability of amylose fractions in aqueous solutions or gel systems. This leads to undesirable product textural attributes during storage. The methods disclosed herein overcome the instability that is caused by amylose fractions.

With the benefit of this disclosure, those skilled in the art will recognize that the heating treatment may be conducted at atmospheric conditions and is applicable to other methods of heating starches in closed processing systems known in the art, including fluid bed drying, thin film drying, and mechanically agitated thermal reactors.

The starting starch base may be a non-gelatinized granular or pre-gelatinized as known in the prior art. In an aspect, the pre-treated starch is hydrothermally treated at near anhydrous conditions, at temperature between 100° C. to 190° C. for a period of about 15-240 minutes. The resulting starch may be used as is or washed further to remove soluble solutes. The starch product made by this method exhibits a swelling inhibition when cooked in acidic and neutral conditions as typically applied in foods such as soups, sauces, gravies, retort foods, dairy products, frozen foods, microwavable foods, ready meals, and similar foods.

The addition of solutes provides improved granular integrity as characterized by higher differential scanning calorimetry (DSC) peak temperature compared to starches processed without solutes.

Salt provides protection against thermal degradation as evidenced by higher molecular weight of resultant products produced with salt addition compared to products produced without salt addition.

A new process of producing physically modified starch is disclosed that is based on heat treatment of starches in presence of salts, such as sodium sulfate, and/or sodium chloride. In an aspect, the thermal processing of starch uses the following conditions: (i) Salt concentration as % added salt (w/w) in starch slurry, from 1 to 40%, w/w, of starch dry weight basis; (ii) % Moisture of starch ranging from near anhydrous condition (˜1%) to 30% on dry weight basis of starch; (iii) Alkalinity of starch adjusted using sodium carbonate or sodium hydroxide to pH>8, preferably between pH 8-11, most preferably at pH 8.5-9.5; (iv) Heating temperature: 100° C.-190° C., preferably between 150° C.-180° C.; (v) Time of heating treatment from 15 minutes to 240 minutes for a range of starch products; and (vi) Heating treatment is done at atmospheric conditions and is applicable to other methods of heating starches in closed processing systems as known in the art, including thin film drying and mechanically agitated thermal reactors, e.g., reactors of Lödige Industries Group, of Lödige Industries GmbH, of Warburg, Germany, or reactors of Littleford Day Company of Florence, Ky.

The physically modified starch prepared in accordance with aspects of the disclosure herein demonstrated inhibited swelling during gelatinization of starch in excess water. Analysis was performed using a Rapid Visco Analyzer (RVA). Viscoamylographs were run for the compositions made in accordance with the examples.

Starches made in accordance with the disclosed method herein show viscosity stability when solubilized in excess water, which is an essential texture desired in food products where starch is used as thickener.

Those skilled in the art will recognize that with the benefit of aspects of the disclosure herein, the addition of salt, heating temperatures, and heating times, and combinations thereof enable the producing of a starch product with better color and stronger/robust starch granules (for better processing tolerance) than that of the control (starch prepared with 0 g sodium sulfate).

The starch based thermal dehydration treatment can be performed at temperatures of 100 to 130° C. for 15 minutes to an hour; and the thermal heat treatment at temperatures of 140° C. to 190° C., preferably at 150-180° C., for a treatment of up to 6 hours, preferably for 1 to 3 hours. While the dehydration or heat treatment temperature can be higher than 130° C. or 180° C., the higher temperatures have a tendency to produce undesirable color formation in a starch/flour-based system. While the dehydration temperature can be lower than 100° C., the higher temperatures will be more effective in removing moisture in a starch/flour-based system. Similarly, while the heat treatment temperature can be lower than 140° C., the higher temperatures will be more effective for the progress of thermal inhibition of a starch/flour-based system.

Those skilled in the art will recognize that with the benefit of aspects of the disclosure herein, this technology can be applied to a variety of cereal/grain flours and starch/flour compositions to obtain physically modified starches, and model/real food application comprising the physically modified starches, with desirable characteristics. Such desirable characteristics may include, but are not limited to, viscosity and/or stability characteristics.

Those skilled in the art will recognize that with the benefit of aspects of the disclosure herein, a starch viscosity profile as a function of pH, and having desired shear characteristics can be obtained in a model/real food application.

Those skilled in the art will recognize that with the benefit of aspects of the disclosure herein, an improved viscosity stability over time can be obtained in a model/real food application.

Those skilled in the art will recognize that with the benefit of aspects of the disclosure herein, refrigerated and freeze-thaw stability characteristics can be obtained in a model/real food application.

In an aspect, a process is disclosed herein for producing a dry pre-treated starch via a starch slurry method or a dry starch process, or a combination thereof. In an embodiment, the starch slurry method comprises the following aspects: (i) mixing starch with water, thus producing a starch slurry; (ii) adding a soluble solutes to the starch slurry or to the water prior to adding starch; (iii) salt solution range from 1-40% soluble solids (S.S), w/w in water, more preferably to be 5-30%, S.S, w/w in water; (iv) Adjusting the pH of the starch slurry to 8-10 using an alkali, e.g., sodium carbonate; and (v) dewatering the starch slurry to recover starch solids.

In an embodiment, the dry starch method comprises mixing dry starch, as is, with salt brine and alkali solution using high speed mixing equipment, e.g., a paddle mixer, such as a Turbulizer® (by Bepex International LLC, Minneapolis, Minn.) or a peripheral mixing system, such a CoriMix® system (by Lödige Process Technology, Pederborn, Germany).

In an embodiment, a combination of the starch slurry method and the dry starch method comprises the following aspects: (i) use the starch slurry method to impregnate a starch with solutes as described above, followed by recovering dried starch solids, and then mixing the dry starch solids with an alkali solution to adjust pH from 8 to 10 using a high speed mixer; or (ii) use the starch slurry method to impregnate with alkali first, followed by mixing dry starch with salt brine in a high speed mixer.

In an embodiment, the pre-treated starch is adjusted to a pH of 8 to 10, preferably 8.5 to 9.5, with dissolved soluble solutes added at 5-30%, preferably 10-25%, by weight of starch slurry.

In an embodiment, the pre-treated starch is thermally processed using a thermal reactor that is agitated via a mechanical or fluidized mechanism in a closed chamber in a batch or continuous mode of operation. The term “thermally inhibited” starch or flour as used in the description herein refers to a granular starch or flour that is thermally treated to provide a modified viscosity characteristic similar to that of a chemically crosslinked starch or flour.

In an embodiment, the starch thermal treatment is performed at temperatures of 100° C. to 130° C. for 15 minutes to an hour.

In an embodiment, the heat treatment is continued at temperatures of 140° C. to 190° C., preferrably at 150-180° C., for a treatment of up to 6 hours, preferably for 1 to 3 hours.

In an embodiment, the starch thermal treatment at lower temperature may be skipped (i.e., not performed at temperatures of 100° C. to 130° C. for 15 minutes to an hour), and the starch is heated directly to higher temperatures (at temperatures of 140° C. to 190° C., preferrably at 150-180° C., for a treatment of up to 6 hours, preferably for 1 to 3 hours), thereby combining the thermal/heat treatment steps as described above into one step.

In an embodiment, a sweep gas may be used during thermal treatment. The sweep gas may be a mixture of air, nitrogen, oxygen, and carbon dioxide such that oxygen content is up to 21% by volume of the sweep gas. In an embodiment, the humidity of sweep gas mixture is controlled from a range of 1.49×10⁻⁷ LBS H2O/Cu ft to a high of 1.52×10⁻³ LBS H2O/Cu ft.

In an embodiment, the heat-treated starch may be washed with water to remove soluble matter.

In an embodiment, a product may be made in accordance with the above process aspects, wherein the starch is a waxy, native type, or amylose-rich starch or hybrids that are available from a range of botanical origins such as corn, tapioca, potato, barley, wheat, pea, rice, lentil, etc. or a combination thereof. In an embodiment, the product may be made using a process applied to fine tune a swelling inhibition characterized by a swelling factor of 11 to 17. In an embodiment, the product may be made having a molecular weight (Mol. Wt.) ranging from 300 kDa to 18000 kDa (i.e., kilodaltons), and/or having a hydrodynamic radius ranging from 150 nm to 600 nm (i.e., nanometers).

In an embodiment, a product may be made wherein the starting starch or flour material contains a minimum starch content of 30% and the product is derived from a variety of grain and non-grain agricultural feedstocks, such as potato, tapioca, waxy tapioca, yellow pea, fava bean, wrinkled pea, and lentil.

In an embodiment, products produced by the above process may have end use applications as processed foods as categorized in shelf-stable foods, refrigerated and frozen foods, beverages, and nutritional supplements, including but not limited to soups, sauces, dairy products, processed meats, yogurts, dressings, frozen foods, juices, confectionary, and bakery fillings. In an embodiment, a process comprises producing a physically modified starch based product derived from a grain and/or non-grain natural feedstocks as disclosed above, and adding the physically modified starch to a food to form a shelf-stable food having improved properties over the same food that does not have the addition of the physically modified starch. In an embodiment, the physically modified starch may be added to a food selected from the group consisting of a food that is or will be refrigerated, or a food that is or will be frozen. In an embodiment, the physically modified starch may be added to a food selected from the group consisting of a soup, sauce, dairy product, processed meat, yogurt, dressing, frozen food, juice, confectionary product, and bakery filling, and combinations thereof.

### Examples

Feed Starch Preparation. Aspects of the process include a feed starch preparation in accordance with the following: (1) a 40% dry solids (DS) slurry was made by adding 300 grams DS of the desired starch or blend of starches to deionized (DI) water; (2) for a sample in which a solute was added, then 60 grams of solute was added to the slurry; (3) the pH was adjusted to about 8-10 with 6% sodium carbonate solution; (4) the slurry was dewatered on a Buchner funnel with Whatman® No. 1 filter paper; (5) the starch was dried in an oven at 40° C., until a moisture content of less than 12% by weight was achieved; and (6) the dried material was ground in a Perten LM3100 mill.

Dry Thermal Treatment. An exemplary dry thermal treatment in accordance with aspects of the disclosure include the following: (1) 30 grams of material from the feed starch preparation above was evenly distributed in the bottom of a 2000 ml stainless steel beaker; (2) a sweep gas distributer was added to the center of the stainless steel beaker to allow for introduction of the sweep gas evenly above the starch; (3) the beaker was topped with aluminum foil with a number of small holes into it; (4) sweep gas tubing was run from the distributer to a gas-drying unit (in the example, a Drierite™ gas-drying unit was used—Drierite™ is a trademark of W.A. Hammond Direrite Co., Ltd.), and further run to a gas rotameter connected to compressed air (in the example, a Cole-Parmer® GMR2-010001 was used as the gas rotameter); (6) the sweep gas flow rate was set to 185 ml/minute and held for 10 minutes before proceeding; (7) the temperature of the oven was raised to 120° C. for 50 minutes; (8) the temperature of the oven was raised to final desired temperature (150-180° C.) for 1-3 hours; and (9) the beaker was removed from the oven and allowed to cool under ambient conditions.

Washing. An exemplary washing in accordance with aspects of the disclosure include the following: (1) 20 g of thermally inhibited starch was added to 100 grams of DI water in a glass beaker and stirred with a stir bar; (2) the pH of the slurry was adjusted to 5.5 with 0.20 N sulfuric acid (i.e., 0.20 normal or 0.20 moles of hydrogen ions per liter, and since this is sulfuric acid, it is 0.10 moles of sulfuric acid per liter); (3) The slurry was dewatered on a Buchner funnel with Whatman® No. 1 filter paper, and before the cake cracks, it was washed with an additional 72 ml of DI water; (4) the cake was dried overnight in an oven at 40° C.; and (5) the sample was ground in a coffee grinder.

Tables 1 through 10 show aspects of the invention.

### Definitions and Analysis Methods

Differential Scanning calorimetery (DSC). The thermal characteristics of inhibited starches were monitored using TA instrument DSC2500. 10 milligrams DS of inhibited starch and 30 milligrams of DI water were added in a DSC pan and equilibrated overnight (about 16-20 hr, i.e., hours) at room temperature. The DSC parameters were set to 5° C./minute rate from 25° to 170° C. The temperatures associated with the gelatinization process, onset temperature (To), peak temperature (Tp), and enthalpy of gelatinization (J/g, i.e., Joules/gram) were analyzed on the DSC thermograms using Trios software. Thermal characteristics analyzed by DSC are shown in Table 1 for various identified starches and starch blends. As shown in Table 1, the addition of a suitable solute, in e.g., sodium sulfate, provides improved granular integrity as characterized by higher DSC peak temperature compared to the same thermally inhibited starch without addition of the solute. The term “solute” and “additive” and “salt” are used interchangeably in this disclosure.

TABLE 1
Thermal characteristics analyzed by DSC

| | | | | | Thermal characteristics | | |
|---|---|---|---|---|---|---|---|
| | | Process conditions | | | Onset | Peak | |
| Sample | | | Temperature | Time | Temperature | Temperature | Enthalpy |
| No. | Sample Name | pH | (° C.) | (hr) | (° C.) | (° C.) | (J/g) |
| 1 | Native Waxy Corn Starch | — | — | — | 66.93 | 72.81 | 18.132 |
| 2 | Thermally Inhibited Waxy | 8.75 | 170 | 2 | 61.00 | 66.68 | 12.253 |
| | Corn Starch | | | | | | |
| 3 | Thermally Inhibited Waxy | 8.75 | 170 | 2 | 61.74 | 67.23 | 13.223 |
| | Corn Starch treated with | | | | | | |
| | Sodium Sulfate additive | | | | | | |
| 4 | Native Dent Corn Starch | — | — | — | 67.25 | 71.02 | 12.943 |
| 5 | Thermally Inhibited Dent | 9.00 | 160 | 1.25 | 60.88 | 65.55 | 10.519 |
| | Corn Starch | | | | | | |
| 6 | Thermally Inhibited Dent | 9.00 | 160 | 1.25 | 62.06 | 67.21 | 11.548 |
| | Corn Starch treated with | | | | | | |
| | Sodium Sulfate additive | | | | | | |
| 7 | Native Tapioca Starch | — | — | — | 63.41 | 68.64 | 14.381 |
| 8 | Thermally Inhibited | 9.00 | 170 | 0.75 | 58.80 | 63.32 | 11.627 |
| | Tapioca Starch | | | | | | |
| 9 | Thermally Inhibited | 9.00 | 170 | 0.75 | 60.12 | 65.36 | 11.712 |
| | Tapioca Starch treated with | | | | | | |
| | Sodium Sulfate additive | | | | | | |
| 10 | Thermally Inhibited | 9.00 | 160 | 1.25 | 59.72 | 64.68 | 9.968 |
| | Tapioca and Thermally | | | | | | |
| | Inhibited Dent Corn Starch | | | | | | |
| | Blend (50-50% blend) | | | | | | |
| 11 | Thermally Inhibited | 9.00 | 160 | 1.25 | 59.98 | 65.38 | 10.338 |
| | Tapioca and Thermally | | | | | | |
| | Inhibited Dent Corn Starch | | | | | | |
| | Blend (50-50% blend) with | | | | | | |
| | Sodium Sulfate additive | | | | | | |

Rapid Visco Analyzer (RVA). Viscosity profile of inhibited starches was analyzed using Rapid Visco Analyzer (RVA) from Perten instruments. 1.54 grams DS of inhibited starch was suspended in 25 grams of RVA neutral buffer (pH 6.5). The viscosity profile was obtained according to the following regime: initial temperature of 25° C., mixing at 960 rpm for 15 seconds and then at 160 rpm for the whole profile, heating to 95° C. at a rate of 14° C./minute, holding at 95° C. for 7 minutes, cooling to 50° C. at a rate of 4.5° C./minute, and mixing for 10 minutes at 50° C. The value of starting viscosity was detected from the viscosity profile when the differential in viscosity was less than 1.2 cp/s during heating cycle; ending viscosity at 95° C. was defined as the viscosity at the end of heating cycle at 95° C.; slope viscosity was defined between starting and end viscosity at 95° C. over time; and final viscosity at 50° C. was the concluding viscosity after cooling cycle and mixing for 10 minutes. Viscosity characteristics analyzed by RVA viscoamylograph are shown in Table 2 for various identified starches and starch blends (all blends were 50-50% of each of two starches in the blend). As shown in Table 2, the addition of a suitable solute, in e.g., sodium sulfate, provides inhibited swelling characterized by viscosity in centipoise (cp) units.

In an embodiment, native waxy corn starch can be modified to provide inhibited swelling characterized by viscosity in cp units. As shown in Table 2, native waxy corn starch was modified with thermal treatment for two hours at an oven temperature of 170° C. and at a pH of 8.75, and was also modified with the same thermal treatment having the process conditions of pH of 8.75, at an oven temperature 170° C. and treatment with sodium sulfate additive. As shown in Table 2, for native waxy corn starch, starting/ending/final viscosity at 95° C./95° C./50° C. was modified from 1488/554/646 cp to 220/529/813 cp respectively when subjected to thermal treatment at pH of 8.75, and to 313/464/628 cp respectively when subjected to thermal treatment at pH 8.75 with sodium sulfate addition. As shown in Table 2, for native waxy corn starch, an RVA swelling behavior characterized by a slope factor cp/s (i.e., seconds) was modified from −2.10 cp/s to 0.66 cp/s when subjected to thermal treatment at pH 8.75, and to 0.32 cp/s when subjected to thermal treatment at pH 8.75 with sodium sulfate addition. RVA swelling behavior characterized by a slope factor of −2.1 cp/s to 0.66 represents a low to high levels of inhibition. Those skilled in the art will recognize that with the benefit of this disclosure, the use of sodium sulfate for dry thermal treatment of waxy corn starch, allows for fine-tuning of viscosity characteristics in the final starch product.

In an embodiment, native dent corn starch (which is an amylose containing starch) can be modified to provide inhibited swelling characterized by viscosity in cp units. As shown in Table 2, native dent corn starch was modified with thermal treatment for 1.25 hours at an oven temperature of 160° C. and at a pH of 9.0, and was also modified with the same thermal treatment having the process conditions of pH of 9.0, at an oven temperature 160° C. and treatment with sodium sulfate additive. As shown in Table 2, for native dent corn starch, starting/ending/final viscosity at 95° C./95° C./50° C. was modified from 585/441/717 cp to 78/134/236 cp respectively when subjected to thermal treatment at pH of 9.0, and to 187/278/523 cp respectively when subjected to thermal treatment at pH 9.0 with sodium sulfate addition. As shown in Table 2, for native dent corn starch, an RVA swelling behavior characterized by a slope factor cp/s (i.e., seconds) was modified from −0.37 cp/s to 0.21 cp/s when subjected to thermal treatment at pH 9.0, and to 0.35 cp/s when subjected to thermal treatment at pH 9.0 with sodium sulfate addition. RVA swelling behavior characterized by a slope factor of −0.37 cp/s to 0.35 represents a low to high levels of inhibition. Those skilled in the art will recognize that with the benefit of this disclosure, the use of sodium sulfate for dry thermal treatment of dent corn starch, allows for fine-tuning of viscosity characteristics in the final starch product.

As shown in Table 2, native tapioca starch, can be modified to provide inhibited swelling characterized by viscosity in cp units. As shown in Table 2, native tapioca starch was modified with thermal treatment for 0.75 hours at an oven temperature of 170° C. and at a pH of 9.0, and was also modified with the same thermal treatment having the process conditions of pH of 9.0, at an oven temperature 160° C. and treatment with sodium sulfate additive. As shown in Table 2, for native tapioca starch, starting/ending/final viscosity at 95° C./95° C./50° C. was modified from 1268/594/909 cp to 65/411/658 cp respectively when subjected to thermal treatment at pH of 9.0, and to 508/616/955 cp respectively when subjected to thermal treatment at pH 9.0 with sodium sulfate addition. As shown in Table 2, for native tapioca starch, an RVA swelling behavior characterized by a slope factor cp/s (i.e., seconds) was modified from −1.59 cp/s to 0.69 cp/s when subjected to thermal treatment at pH 9.0, and to 0.24 cp/s when subjected to thermal treatment at pH 9.0 with sodium sulfate addition. RVA swelling behavior characterized by a slope factor of −1.59 cp/s to 0.69 represents a low to high levels of inhibition. Those skilled in the art will recognize that with the benefit of this disclosure, the use of sodium sulfate for dry thermal treatment of tapioca starch, allows for fine-tuning of viscosity characteristics in the final starch product.

As shown in Table 2, for a 50-50 blend of thermally inhibited tapioca and dent corn starch with sodium sulfate addition provides further fine-tuning of viscosity and RVA swelling behavior characterized by a slope factor representing low to high levels of inhibition. For example, compare slope factor of −1.59 cp/s for native tapioca starch to the slope factor of 0.64 for the 50-50 blend of thermally inhibited tapioca and dent corn starch under process conditions of a pH of 9.0 at an oven temperature of 160° C. and treatment with sodium sulfate additive.

TABLE 2
Viscosity characteristics analyzed by RVA viscoamylograph

| | | | | | Viscosity characteristics | | | |
|---|---|---|---|---|---|---|---|---|
| | | Process conditions | | | Starting | Ending | | Final |
| | | | Temp. | Time | cp at | cp at | Slope | at cp |
| No. | Sample Name | pH | (° C.) | (hr) | 95° C. | 95° C. | (cp/s) | 50° C. |
| 1 | Native Waxy Corn Starch | — | — | — | 1488 | 554 | −2.10 | 646 |
| 2 | Thermally Inhibited Waxy | 8.75 | 170 | 2 | 220 | 529 | 0.66 | 813 |
| | Corn Starch | | | | | | | |
| 3 | Thermally Inhibited Waxy | 8.75 | 170 | 2 | 313 | 464 | 0.32 | 628 |
| | Corn Starch treated with | | | | | | | |
| | Sodium Sulfate additive | | | | | | | |
| 4 | Native Dent Corn Starch | — | — | — | 585 | 441 | −0.37 | 717 |
| 5 | Thermally Inhibited Dent | 9.00 | 160 | 1.25 | 78 | 134 | 0.21 | 236 |
| | Corn Starch | | | | | | | |
| 6 | Thermally Inhibited Dent | 9.00 | 160 | 1.25 | 187 | 278 | 0.35 | 523 |
| | Corn Starch treated with | | | | | | | |
| | Sodium Sulfate additive | | | | | | | |
| 7 | Native Tapioca Starch | — | — | — | 1268 | 594 | −1.59 | 909 |
| 8 | Thermally Inhibited Tapioca | 9.00 | 170 | 0.75 | 65 | 411 | 0.69 | 658 |
| | Starch | | | | | | | |
| 9 | Thermally Inhibited Tapioca | 9.00 | 170 | 0.75 | 508 | 616 | 0.24 | 955 |
| | Starch treated with Sodium | | | | | | | |
| | Sulfate additive | | | | | | | |
| 10 | Thermally Inhibited Tapioca | 9.00 | 160 | 1.25 | 65 | 259 | 0.46 | 390 |
| | and Thermally Inhibited Dent | | | | | | | |
| | Corn Starch Blend (50-50% | | | | | | | |
| | blend) | | | | | | | |
| 11 | Thermally Inhibited Tapioca | 9.00 | 160 | 1.25 | 101 | 369 | 0.64 | 516 |
| | and Thermally Inhibited Dent | | | | | | | |
| | Corn Starch Blend (50-50% | | | | | | | |
| | blend) with Sodium Sulfate | | | | | | | |
| | additive | | | | | | | |

Swelling factor as referred to herein is calculated in the following manner: (1) 300 milligrams DS of thermally inhibited starch and 29.700 grams of DI water were added to a centrifuge tube; (2) the centrifuge tube was incubated in a water bath at 75° C. for 30 minutes; (3) immediately after incubation, the tube was cooled down using running cold water for 5 minutes prior to centrifugation; (4) the tube was then centrifuged at 3000×g (centrifugal force) for 30 minutes and the supernatant was then removed; (5) 5.000 grams of the supernatant was dried in an aluminum boat using hot plate at 130° C. for 2 hours, and the weight change of supernatant after drying was used to calculate solubility; and (6) the net weight of sediment in the tube was used to calculate the swelling factor. Swelling factor characteristics are shown in Table 3 for various identified starches and starch blends. As shown in Table 3, for waxy corn starch, the addition of a suitable solute, in e.g., sodium sulfate additive, may be applied to fine tune a swelling inhibition characterized by a swelling factor of about 14 (see Table 3, which shows a swelling factor value of 13.97 for thermally inhibited native waxy corn starch). For amylose containing starches (such as native dent corn starch, native tapioca starch, and a blend of native dent corn starch and tapioca starch), the addition of a suitable solute, e.g., sodium sulfate additive, may be applied to fine tune a swelling inhibition characterized by a swelling factor of about 12.9 to about 16.3 (see Table 3, which shows swelling factor values of 12.93 for thermally inhibited native dent corn starch treated with sodium sulfate additive, 16.34 for thermally inhibited native tapioca starch treated with sodium sulfate additive, and 13.80 for a 50-50% blend of thermally inhibited native tapioca and thermally inhibited native dent corn starch treated with sodium sulfate).

TABLE 3
Swelling factor characteristics

| | | Process conditions | | | Swelling |
|---|---|---|---|---|---|
| Sample | | | Temperature | Time | Factor |
| No. | Sample Name | pH | (° C.) | (hr) | (%) |
| 1 | Native Waxy Corn Starch | — | — | — | 15.78 |
| 2 | Thermally Inhibited Waxy Corn Starch | 8.75 | 170 | 2 | 14.50 |
| 3 | Thermally Inhibited Waxy Corn Starch treated | 8.75 | 170 | 2 | 13.97 |
| | with Sodium Sulfate additive | | | | |
| 4 | Native Dent Corn Starch | — | — | — | 11.55 |
| 5 | Thermally Inhibited Dent Corn Starch | 9.00 | 160 | 1.25 | 12.01 |
| 6 | Thermally Inhibited Dent Corn Starch treated | 9.00 | 160 | 1.25 | 12.93 |
| | with Sodium Sulfate additive | | | | |
| 7 | Native Tapioca Starch | — | — | — | 14.18 |
| 8 | Thermally Inhibited Tapioca Starch | 9.00 | 170 | 0.75 | 15.41 |
| 9 | Thermally Inhibited Tapioca Starch treated | 9.00 | 170 | 0.75 | 16.34 |
| | with Sodium Sulfate additive | | | | |
| 10 | Thermally Inhibited Tapioca and Dent Corn | 9.00 | 160 | 1.25 | 12.98 |
| | Starch Blend (50-50% blend) | | | | |
| 11 | Thermally Inhibited Tapioca and Dent Corn | 9.00 | 160 | 1.25 | 13.80 |
| | Starch Blend (50-50% blend) with Sodium | | | | |
| | Sulfate additive | | | | |

Molecular weight and hydronamic radius. Molecular weight and size information of inhibited starches were analyzed using gel permeation chromatography (GPC) technique. A GPC EcoSEC system from Tosoh Bioscience and a Multi-Angle Light Scattering, Differential Viscometer, and Differential Refractometer detectors from Wyatt Technology were utilized. 25 milligrams DS of inhibited starch was solubilized in 5 mL dimethylsulfoxide-lithium bromide (DMSO-LiBr) solution (0.5 wt %). The mixture was then heated at 100° C. for 2 hours while mixing. Samples were then kept mixing overnight at room temperature. Solvent flow rate for analysis was set to 0.6 mL min⁻¹ and 100 μL of prepared sample was injected to the GPC system. Molecular weight and hydrodynamic radius were analyzed using ASTRA software. Molecular weight and hydrodynamic radius characteristics are shown in Table 4 for various identified starches and starch blends. As shown in Table 4, a suitable salt or solute, e.g., sodium sulfate, provides protection against thermal degradation as evidenced by greater molecular weight and higher hydrodynamic radius of resultant products produced with salt addition compared to those without salt addition. As shown in Table 4, the addition of sodium sulfate increased the molecular weight of thermally inhibited waxy corn starch from 7329 kDa to 12619 kDa (an increase of about 72.2%), and increased the hydrodynamic radius from 329.1 nm to 360.2 nm (an increase of about 9.5%). As shown in Table 4, the addition of sodium sulfate increased the molecular weight of thermally inhibited dent corn starch from 2746 kDa to 4358 kDa (an increase of about 58.7%), and increased the hydrodynamic radius from 309.1 nm to 350.1 nm (an increase of about 13.3%). As shown in Table 4, the addition of sodium sulfate increased the molecular weight of thermally inhibited tapioca starch from 10580 kDa to 13173 kDa (an increase of about 24.5%), and increased the hydrodynamic radius from 328.0 nm to 368.7 nm (an increase of about 12.4%). As shown in Table 4, the addition of sodium sulfate increased the molecular weight of thermally inhibited tapioca starch from 10580 kDa to 13173 kDa (an increase of about 24.5%), and increased the hydrodynamic radius from 328.0 nm to 368.7 nm (an increase of about 12.4%). As shown in Table 4, the addition of sodium sulfate increased the molecular weight of thermally inhibited tapioca starch and dent corn starch blend (50-50 blend) from 8357 kDa to 9028 kDa (an increase of about 8.0%), and increased the hydrodynamic radius from 357.5 nm to 382.5 nm (an increase of about 7.0%).

TABLE 4
Molecular weight and hydrodynamic radius characteristics

| | | | | | Fine structure | |
|---|---|---|---|---|---|---|
| | | | | | characteristics | |
| | | Process conditions | | | | Hydrodynamic |
| Sample | | | Temp. | Time | Mol Wt | Radius |
| No. | Sample Name | pH | (° C.) | (hr) | (kDa) | (nm) |
| 1 | Thermally Inhibited Waxy | 8.75 | 170 | 2 | 7329 | 329.1 |
| | Corn Starch | | | | | |
| 2 | Thermally Inhibited Waxy | 8.75 | 170 | 2 | 12619 | 360.2 |
| | Corn Starch treated with | | | | | |
| | Sodium Sulfate additive | | | | | |
| 3 | Thermally Inhibited Dent | 9.00 | 160 | 1.25 | 2746 | 309.1 |
| | Corn Starch | | | | | |
| 4 | Thermally Inhibited Dent | 9.00 | 160 | 1.25 | 4358 | 350.1 |
| | Corn Starch treated with | | | | | |
| | Sodium Sulfate additive | | | | | |
| 5 | Thermally Inhibited | 9.00 | 170 | 0.75 | 10580 | 328.0 |
| | Tapioca Starch | | | | | |
| 6 | Thermally Inhibited | 9.00 | 170 | 0.75 | 13173 | 368.7 |
| | Tapioca Starch treated with | | | | | |
| | Sodium Sulfate additive | | | | | |
| 7 | Thermally Inhibited | 9.00 | 160 | 1.25 | 8357 | 357.5 |
| | Tapioca and Dent Corn | | | | | |
| | Starch Blend (50-50 blend) | | | | | |
| 8 | Thermally Inhibited | 9.00 | 160 | 1.25 | 9028 | 382.5 |
| | Tapioca and Dent Corn | | | | | |
| | Starch Blend (50-50 blend) | | | | | |
| | with Sodium Sulfate | | | | | |
| | additive | | | | | |

Colorimeter. Color characterization of inhibited starches was analyzed using HunterLab ColorFlex EZ. Changes in the yellow index (YI) due to the thermal inhibition process with and without sodium sulfate additive were monitored. Color characteristics are shown in Table 5 for various identified starches and starch blends. As shown in Table 5, a suitable salt or solute, e.g., sodium sulfate, provides protection against undesirable color formation. As shown in Table 5, the addition of sodium sulfate decreased the yellow index (i) of thermally inhibited waxy corn starch from 18.39 to 18.05 (a decrease of about 2.0%); (ii) of thermally inhibited dent corn starch from 19.39 to 18.96. (a decrease of about 2.2%); (iii) of thermally inhibited tapioca starch from 18.85 to 17.78 (a decrease of about 5.7%); and (iv) of thermally inhibited tapioca starch and dent corn starch blend (50-50 blend) from 18.86 to 18.32. (a decrease of about 2.9%).

TABLE 5
Color characteristics (additional data)

| | | Process conditions | | | Yellow |
|---|---|---|---|---|---|
| Sample | | | Temperature | Time | Index |
| No. | Sample Name | pH | (° C.) | (hr) | (YI) |
| 1 | Thermally Inhibited Waxy Corn | 8.75 | 170 | 2 | 18.39 |
| | Starch | | | | |
| 2 | Thermally Inhibited Waxy Corn | 8.75 | 170 | 2 | 18.03 |
| | Starch treated with Sodium Sulfate | | | | |
| | additive | | | | |
| 3 | Thermally Inhibited Dent Corn Starch | 9.00 | 160 | 1.25 | 19.39 |
| 4 | Thermally Inhibited Dent Corn Starch | 9.00 | 160 | 1.25 | 18.96 |
| | treated with Sodium Sulfate additive | | | | |
| 5 | Thermally Inhibited Tapioca Starch | 9.00 | 170 | 0.75 | 18.85 |
| 6 | Thermally Inhibited Tapioca Starch | 9.00 | 170 | 0.75 | 17.78 |
| | treated with Sodium Sulfate additive | | | | |
| 7 | Thermally Inhibited Tapioca and Dent | 9.00 | 160 | 1.25 | 18.86 |
| | Corn Starch Blend | | | | |
| 8 | Thermally Inhibited Tapioca and Dent | 9.00 | 160 | 1.25 | 18.32 |
| | Corn Starch Blend with Sodium | | | | |
| | Sulfate additive | | | | |

Various solutes were tested to determine respective impact on viscosity and color characteristics for native waxy corn starch. Table 6 shows the impact of sodium sulfate, sodium chloride, potassium iodide, and trehalose additives on viscosity and color characteristics for thermally inhibited waxy corn starch.

TABLE 6
Effect of solutes on viscosity and color characteristics

| | | | | | Viscosity characteristics | | | | |
|---|---|---|---|---|---|---|---|---|---|
| | | Process conditions | | | Starting | Ending | | Final | Yellow |
| Sample | | | Temperature | Time | cp at | cp at | Slope | cp at | Index |
| No. | Sample Name | pH | (° C.) | (hr) | 95° C. | 95° C. | (cp/s) | 50° C. | (YI) |
| 1 | Native Waxy Corn | — | — | — | 1488 | 554 | −2.10 | 646 | 8.22 |
| | Starch | | | | | | | | |
| 2 | Thermally | 9.50 | 170 | 1 | 256 | 333 | 0.72 | 897 | 19.96 |
| | Inhibited Waxy | | | | | | | | |
| | Corn Starch | | | | | | | | |
| 3 | Thermally | 9.50 | 170 | 1 | 467 | 528 | 0.44 | 984 | 20.68 |
| | Inhibited Waxy | | | | | | | | |
| | Corn Starch treated | | | | | | | | |
| | with Sodium | | | | | | | | |
| | Sulfate additive | | | | | | | | |
| 4 | Thermally | 9.50 | 170 | 1 | 568 | 766 | 0.40 | 1066 | 22.20 |
| | Inhibited Waxy | | | | | | | | |
| | Corn Starch treated | | | | | | | | |
| | with Sodium | | | | | | | | |
| | Chloride additive | | | | | | | | |
| 5 | Thermally | 9.50 | 170 | 1 | 483 | 712 | 0.60 | 947 | 31.31 |
| | Inhibited Waxy | | | | | | | | |
| | Corn Starch treated | | | | | | | | |
| | with Potassium | | | | | | | | |
| | Iodide additive | | | | | | | | |
| 6 | Thermally | 9.50 | 170 | 1 | 355 | 661 | 0.63 | 978 | 21.53 |
| | Inhibited Waxy | | | | | | | | |
| | Corn Starch treated | | | | | | | | |
| | with Trehalose | | | | | | | | |
| | additive | | | | | | | | |

Table 7 shows the effect of pH and sodium sulfate on viscosity and color characteristics for thermally inhibited waxy corn starch. As presented in Table 7, sodium sulfate had a different impact on reduction of final viscosity at different pH values. At pH 8.75, final viscosity of sample treated with sodium sulfate was lower compared to the sample at the same pH but treated without sodium sulfate. However, by increasing pH to pH values of 9.0, 9.25, and 9.50, this phenomenon was reversed. Similar phenomenon was observed on yellow index color characteristics. The lowest yellowing color was achieved by thermally inhibited waxy corn starch with sodium sulfate additive at a pH of 8.75, and yellowing color progressively increased at higher pH of 9.0, 9.25, and 9.50. Ultimately, pH is an important factor in the product final color and viscosity characteristics.

TABLE 7
Effect of pH and sodium sulfate on viscosity and color characteristics

| | | | | | Viscosity characteristics | | | | |
|---|---|---|---|---|---|---|---|---|---|
| | | Process conditions | | | Starting | Ending | | Final | Yellow |
| Sample | | | Temp. | Time | cp at | cp at | Slope | cp at | Index |
| No. | Sample Name | pH | (° C.) | (hr) | 95° C. | 95° C. | (cp/s) | 50° C. | (YI) |
| 1 | Thermally | 8.75 | 170 | 2 | 220 | 529 | 0.66 | 813 | 18.39 |
| | Inhibited Waxy | | | | | | | | |
| | Corn Starch | | | | | | | | |
| 2 | Thermally | 8.75 | 170 | 2 | 313 | 464 | 0.32 | 628 | 18.03 |
| | Inhibited Waxy | | | | | | | | |
| | Corn Starch treated | | | | | | | | |
| | with Sodium | | | | | | | | |
| | Sulfate additive | | | | | | | | |
| 3 | Thermally | 9.00 | 170 | 2 | 194 | 490 | 0.64 | 767 | 19.08 |
| | Inhibited Waxy | | | | | | | | |
| | Corn Starch | | | | | | | | |
| 4 | Thermally | 9.00 | 170 | 2 | 391 | 587 | 0.42 | 903 | 19.79 |
| | Inhibited Waxy | | | | | | | | |
| | Corn Starch treated | | | | | | | | |
| | with Sodium | | | | | | | | |
| | Sulfate additive | | | | | | | | |
| 5 | Thermally | 9.25 | 170 | 2 | 88 | 298 | 0.45 | 528 | 22.70 |
| | Inhibited Waxy | | | | | | | | |
| | Corn Starch | | | | | | | | |
| 6 | Thermally | 9.25 | 170 | 2 | 246 | 412 | 0.36 | 610 | 23.33 |
| | Inhibited Waxy | | | | | | | | |
| | Corn Starch treated | | | | | | | | |
| | with Sodium | | | | | | | | |
| | Sulfate additive | | | | | | | | |
| 7 | Thermally | 9.50 | 170 | 2 | 49 | 194 | 0.29 | 393 | 24.80 |
| | Inhibited Waxy | | | | | | | | |
| | Corn Starch | | | | | | | | |
| 8 | Thermally | 9.50 | 170 | 2 | 143 | 353 | 0.42 | 573 | 25.24 |
| | Inhibited Waxy | | | | | | | | |
| | Corn Starch treated | | | | | | | | |
| | with Sodium | | | | | | | | |
| | Sulfate additive | | | | | | | | |

Processes for Physically Modifying Flour and Flour/Starch Compositions.

Aspects of the invention are directed to hydrothermal treatment of flour and flour/starch mixtures. Aspects include the following steps and conditions: (1) spreading a thin layer of flour or flour/starch mixture on a tray without pH adjustment; (2) directly heating the flour or flour/starch mixture at a temperature in the range of about 100-180° C., preferably in the range of about 120-140° C. for about 1-4 hours. In an embodiment, the thermal treatment may be performed in an open atmospheric reactor. In an embodiment, the thermal treatment may be performed in a closed pressure reactor.

In an aspect, this invention discloses a process for preparing thermally inhibited flours and/or starch/flour mixtures without comprising adding any additive, and no dehydration and pH adjustment needed, just directly heat treating flour and/or starch/flour mixtures on a surface to obtain the product. Those skilled in the art, having the benefit of this disclosure, will recognize that this process is a cleaner and simpler process as compare to conventional processes, as well as the conventional processes for preparing thermally inhibited starches.

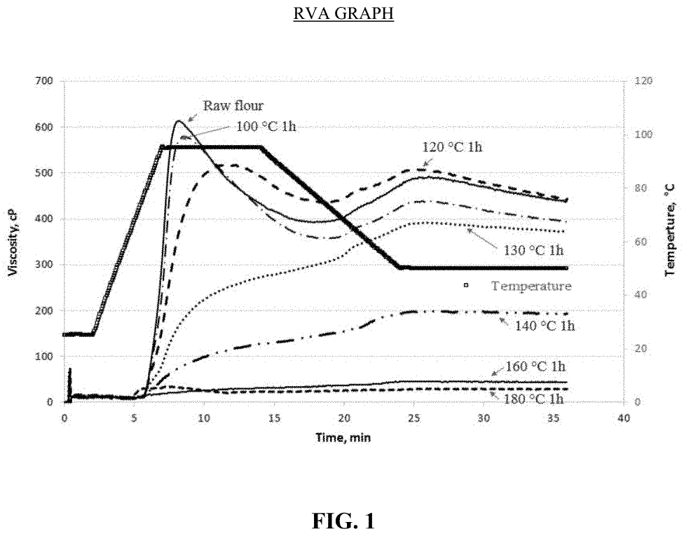

Thermally treated flour compositions as physically modified compositions demonstrate inhibited swelling when cooked in a typical food processing operation. Gelatinization curves in excess water are shown in the RVA graphs (FIG. 1 through FIG. 4). The graphs show swelling inhibition and viscosity stability when cooked in neutral and/or acidic conditions, which is an essential functional property for a texturizing ingredient in food products.

In an aspect, the processes disclosed herein produce a flour and/or starch/flour mixture product having acceptable color and a much stronger or more robust granules for better processing tolerances than native flour or starch (Tables 8 and 9). The final viscosities of the physically modified compositions are very stable for longer time cooking processes both in neutral and acid conditions than native flour or starch (FIGS. 1-4).

TABLE 8
Color characteristics

| | Process conditions | | | | | |
|---|---|---|---|---|---|---|
| | Temperature | Time | Color characteristics | | | |
| Sample Name | (° C.) | (hr) | YI | L* | a* | b* |
| Native Waxy Corn Flour (control)-unheated | — | — | 47.41 | 85.16 | 2.53 | 24.64 |
| Thermally Inhibited Waxy Corn Flour | 100 | 1 | 49.47 | 84.31 | 2.40 | 25.81 |
| Thermally Inhibited Waxy Corn Flour | 120 | 1 | 46.60 | 84.59 | 2.55 | 23.97 |
| Thermally Inhibited Waxy Corn Flour | 130 | 1 | 48.54 | 82.92 | 2.96 | 24.53 |
| Thermally Inhibited Waxy Corn Flour | 140 | 1 | 55.91 | 79.48 | 4.51 | 27.32 |
| Thermally Inhibited Waxy Corn Flour | 160 | 1 | 65.89 | 70.37 | 7.84 | 28.37 |
| Thermally Inhibited Waxy Corn Flour | 180 | 1 | 75.98 | 60.96 | 9.85 | 29.09 |

Note:
WF (whole waxy corn flour);
L* (+ = lighter, − = darker);
a* (+ = redder, − = greener);
b* (+ = yellower, − = bluer);
YI (Yellowness Index)

TABLE 9
Color characteristics

| | Process conditions | | | | | |
|---|---|---|---|---|---|---|
| | Temperature | Time | Color characteristics | | | |
| Sample Name | (° C.) | (hr) | YI | L* | a* | b* |
| WS (control)-unheated | — | — | 8.23 | 95.29 | −0.21 | 4.45 |
| WF (control)-unheated | — | — | 47.41 | 85.16 | 2.53 | 24.64 |
| Thermally Inhibited WS + 30% WF | 140 | 2 | 27.16 | 88.55 | 1.14 | 13.80 |
| Thermally Inhibited WS + 40% WF | 140 | 2 | 42.76 | 82.77 | 3.60 | 20.62 |
| Thermally Inhibited WS + 50% WF | 140 | 2 | 45.90 | 81.04 | 4.24 | 21.74 |
| Thermally Inhibited WS + 30% WF | 140 | 3 | 30.46 | 86.92 | 1.64 | 15.21 |
| Thermally Inhibited WS + 40% WF | 140 | 3 | 44.68 | 82.03 | 3.66 | 21.56 |
| Thermally Inhibited WS + 50% WF | 140 | 3 | 46.76 | 80.92 | 4.06 | 22.32 |

Note:
WS (waxy corn starch);
WF (whole waxy corn flour);
L* (+ = lighter, − = darker);
a* (+ = redder, − = greener);
b* (+ = yellower, − = bluer);
YI (Yellowness Index)

Materials used in preparation of experimental prototypes included, but were not limited to: (1) whole waxy corn flour; (2) de-germed waxy corn flour; (3) waxy wheat flour; and (4) waxy corn starch. Those skilled in the art will recognize that with the benefit of aspects of the disclosure herein other flours may be used.

Applications of the products produced in accordance with the processes disclosed herein include, but are not limited to, (1) batter and/or breading; (2) baked goods; (3) gravies; (4) sauces; (5) kettle-cooked or dry mix soups.

FIG. 1 is an RVA graph that shows inhibited granular swelling for flours, which were heated at as-is pH values (˜pH 6.0-6.5) in flours, and through various hydrothermal treatment temperatures (120, 130, 140, 160, 180° C.) for 1 hour, in comparison with raw flour that was not subjected to hydrothermal treatment. Viscosity of products when cooking in excess water is shown on the Y axis and time of cooking is shown on the X axis. RVA analysis was performed in neutralized buffer solution.

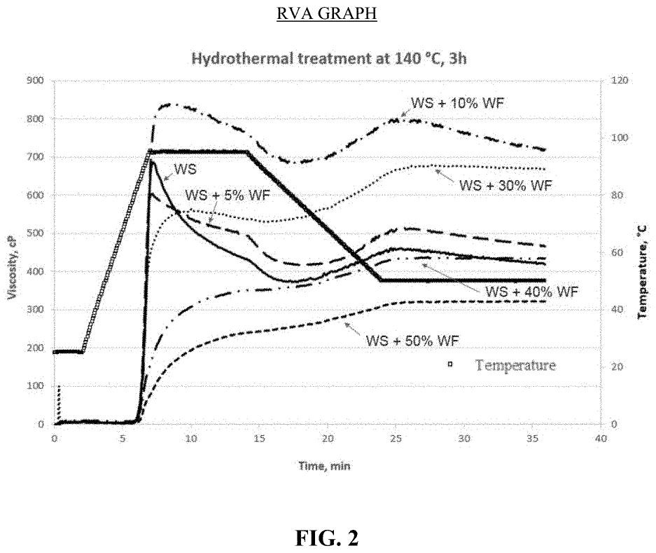

FIG. 2 is an RVA graph that shows inhibited granular swelling for various flour/starch mixtures that were hydrothermally treated at 140° C. for 3 hours in comparison with native waxy corn starch that was not subjected to hydrothermal treatment. Viscosity of products when cooking in excess water is shown on the Y axis and time of cooking is shown on the X axis. RVA analysis was performed in neutralized buffer solution.

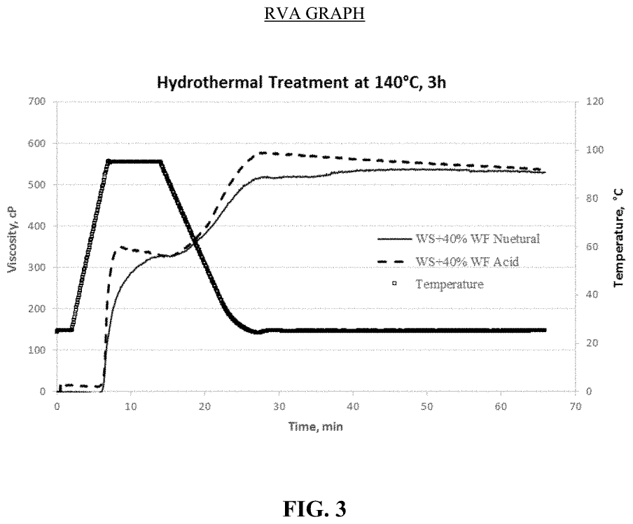

FIG. 3 is an RVA graph that shows inhibited granular swelling for starch/flour mixture (WS+40% WF) hydrothermally treated for 3 hours at 140° C. The cooling process on this product was extended until 1 hour and it showed very stable viscosity even in a long shearing process, both in neutral and acid conditions, indicating a better processing tolerance than native flour (this product even showed higher viscosity in acid condition than that in neutral). This RVA analysis was performed both in neutral buffer solution and acid buffer solution. Viscosity is shown on the Y axis and time of heating in excess water is shown on the X axis.

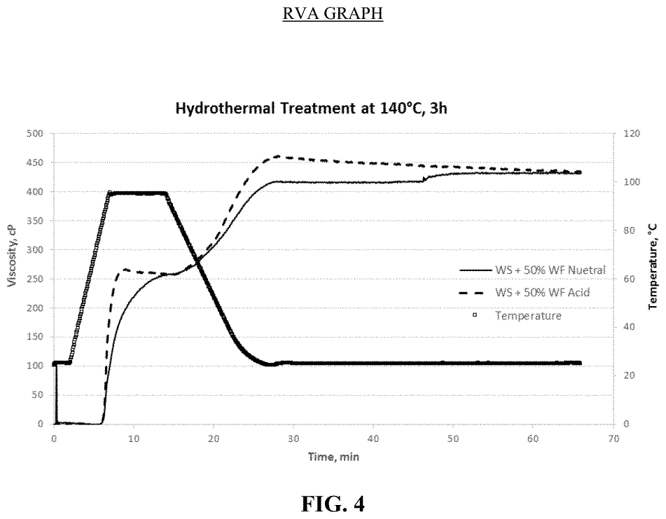

FIG. 4 is an RVA graph that shows inhibited granular swelling for starch/flour mixture (WS+50% WF) hydrothermally treated for 3 hours at 140° C. The cooling process on this product was extended until 1 hour and it showed very stable viscosity even in a long shearing process, both in neutral and acid conditions, indicating a better processing tolerance than native flour (this product even showed higher viscosity in acid condition than that in neutral). This RVA analysis was performed both in neutral buffer solution and acid buffer solution. Viscosity is shown on the Y axis and time of heating in excess water is shown on the X axis.

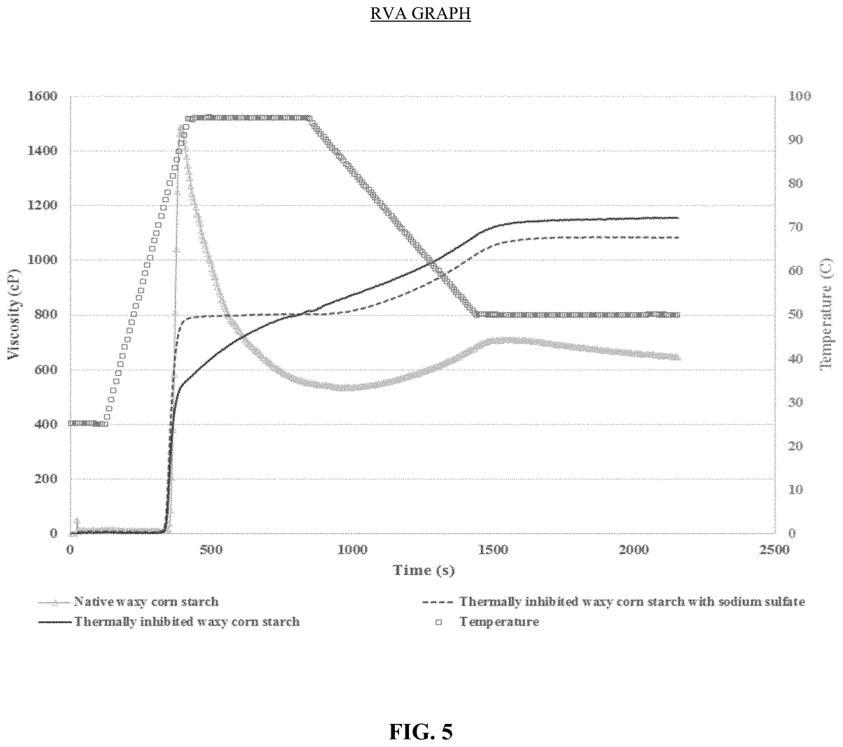

Further example of the benefit of thermal treatment and using a salt as disclosed herein is described below, including the results shown in Table 10, and FIG. 5. Two feed starches were prepared by addition of 300 grams DS of waxy corn starch to DI water to make up a 40% slurry. Then, 60 grams of sodium sulfate was added to the one of the two feed starch slurries and the pH was adjusted to about 9.0 with 6% sodium carbonate solution. Each starch slurry was then dewatered on a Buchner funnel with Whatman® No. 1 filter paper, and each feed starch was dried in an oven at 40° C. until a moisture content of less than 12% was achieved, and the dried materials were ground in a Perten LM3100 mill.

For each of the dried materials without sodium sulfate and with sodium sulfate, 30 grams of material was evenly distributed in the bottom of a 2000 ml stainless steel beaker. A sweep gas distributer was added to the center of the stainless steel beaker to allow for introduction of the sweep gas evenly above the starch. The beaker was topped with aluminum foil with a number of small holes into it. The sweep gas tubing was run from the distributer to a gas humidification unit, and further run to a gas proportioning rotameter connected to compressed air and nitrogen. The proportioning rotameter was set to achieve a 5% oxygen sweep gas. The temperature of the oven was raised to 120° C. for 50 minutes. The temperature of the oven was raised to 170° C. for 1.75 hours and the beaker was removed from the oven and allowed to cool under ambient conditions. Each thermally inhibited waxy starch sample was washed as follows: 20 g of thermally inhibited waxy starch was added to 100 grams of DI water in a glass beaker and stirred with a stir bar. The pH of the slurry was adjusted to 5.5 with 0.20 N sulfuric acid. The slurry was dewatered on a Buchner funnel with Whatman® No. 1 filter paper, to produce a cake, and before the cake cracked, it was washed with an additional 72 ml of DI water. The cake was dried overnight in an oven at 40° C., and the sample was ground in a coffee grinder to obtain physically modified starch having reduced amount of soluble additive than without washing and dewatering.

RVA analysis was followed as described above in prior examples. As shown in FIG. 5 and Table 10, the addition of a suitable salt, here sodium sulfate, resulted in a modified RVA viscosity profile. This discovery provides the capability to fine tune the viscosity profile to meet a desired application.

TABLE 10
Process conditions, viscosity and color characteristics of selected samples of FIG. 6.

| | | | | Viscosity characteristics | | | | Color characteristics | |
|---|---|---|---|---|---|---|---|---|---|
| | Process conditions | | | | Ending | | Final | Yellow | Whiteness |
| | | Temperature | Time | Starting | at 95° C. | Slope | at 50° C. | Index | Index |
| Sample Name | pH | (° C.) | (hr) | (cP) | (cP) | (cP/s) | (cP) | (YI) | (L*) |
| Native Waxy | — | — | — | 1488 | 554 | −2.10 | 646 | 8.22 | 94.64 |
| Corn Starch | | | | | | | | | |
| Thermally | 9.00 | 170 | 1.75 | 542 | 815 | 0.61 | 1155 | 19.05 | 89.06 |
| Inhibited Waxy | | | | | | | | | |
| Corn Starch | | | | | | | | | |
| Thermally | 9.00 | 170 | 1.75 | 786 | 803 | 0.04 | 1083 | 17.58 | 89.44 |
| Inhibited Waxy | | | | | | | | | |
| Corn Starch | | | | | | | | | |
| treated with | | | | | | | | | |
| Sodium Sulfate | | | | | | | | | |
| additive | | | | | | | | | |

Aspects of the disclosure include (i) improved inhibited swelling of starch when heated in water; (ii) unique thickener that shows viscosity stability at ambient, refrigerated and freezer storage temperatures; and these properties are advantageous for soups, sauces, gravies, cereal bars, meats, sausage, cake flour, batter and breading; (iii) chemical-free dry processing of grain based compositions; and (iv) heating temperatures and times and combinations thereof that enables producing a flour and starch/flour product with better color and stronger/robust granules (for better processing tolerance as encountered in typical processed and packaged foods and beverages).

Those skilled in the art having the benefit of this disclosure will recognize that various process parameters, including temperature, and time of dry thermal treatment for other starting flour and flour/starch mixture bases, may be optimized to achieve the desired products. Those skilled in the art will also recognize that the teachings of this disclosure may be applied to a wide variety cereal/grain flour and starch/flour combinations.

As can be seen from the above results, significant improved inhibition of swelling for both flour only and flour/starch mixtures when heated in water can be achieved under the disclosed conditions and with the described mixture components. It is expected that process optimization, based on the teachings herein, can be conducted to further increase improved inhibition of swelling according to the synthesis methods and overall teachings set forth in the present disclosure.

While the aspects described herein have been discussed with respect to specific examples including various modes of carrying out aspects of the disclosure, those skilled in the art will appreciate that various changes can be made to these processes in attaining these and other advantages, without departing from the scope of the present disclosure. As such, it should be understood that the features of the disclosure are susceptible to modifications and/or substitutions without departing from the scope of this disclosure. The specific embodiments illustrated and described herein are for illustrative purposes only, and not limiting of the invention set forth in the appended claims.

1. A process for producing a physically modified starch, comprising:
mixing starch with water to form an aqueous starch mixture;
adding at least one salt to the aqueous starch mixture;
adjusting the pH of the aqueous starch mixture to at least about 8;
dewatering the starch mixture using a filter to obtain filtered solids;
collecting the filtered solids;
drying the filtered solids;
spreading a layer of dried filtered solids on a surface; and
heating the dried filtered solids while on the surface to a temperature of about 100° C. to 190° C. to obtain the physically modified starch.

2. The process of claim 1 wherein after drying and before spreading, the dried filtered solids are ground using a grinder.

3. The process of claim 1 wherein the at least one salt is selected from the group consisting of sodium sulfate, and sodium chloride, potassium chloride, and combinations thereof.

4. The process of claim 1 wherein the pH of the aqueous starch mixture is adjusted to about 8.0-10.0.

5. (canceled)

6. The process of claim 1 wherein the starch is a waxy starch.

7-9. (canceled)

10. The process of claim 1 wherein the surface is selected from the group consisting of a tray, a plate, a belt, or the inside of a vessel.

11. The process of claim 1 wherein after heating the dried filtered solids while on the surface to a temperature of about 100° C. to 190° C., the process further comprises washing the dried filtered solids with water to form a slurry, and dewatering the slurry, thereby removing soluble salt from the dried filtered solids.

12. The process of claim 11 wherein the dewatering comprises filtering to produce a cake, the process further comprising drying the cake and grinding the cake to obtain the physically modified starch having reduced amount of soluble salt than without washing and dewatering.

13-15. (canceled)

16. A process for producing a physically modified starch, comprising:
mixing water with starch to form an aqueous starch mixture;
adding at least one additive to the aqueous starch mixture, wherein the at least one additive is selected from the group consisting of sodium sulfate, sodium chloride, potassium chloride, potassium iodide, and trehalose, and combinations thereof;
adjusting the pH of the aqueous starch mixture to about 8.0-10.0;
dewatering the starch mixture using a filter to obtain filtered solids;
collecting the filtered solids; drying the filtered solids;
spreading a layer of dried filtered solids on a surface; and
heating the dried filtered solids while on the surface to a temperature of about 100° C. to 190° C. to obtain the physically modified starch.

17. The process of claim 16 wherein after drying and before spreading, the dried filtered solids are ground using a grinder.

18-24. (canceled)

25. The process of claim 16 wherein after heating the dried filtered solids while on the surface to a temperature of about 100° C. to 190° C., the process further comprises washing the dried filtered solids with water to form a slurry, and dewatering the slurry, thereby removing soluble additive from the dried filtered solids.

26. The process of claim 25 wherein the dewatering comprises filtering to produce a cake, the process further comprising drying the cake and grinding the cake to obtain the physically modified starch having reduced amount of soluble additive than without washing and dewatering the slurry.

27-29. (canceled)

30. A process for producing a physically modified starch, comprising:
adding at least one additive slurry to a starch in dry powder form, wherein the additive is selected from the group consisting of sodium sulfate, sodium chloride, potassium chloride, potassium iodide, and trehalose, and combinations thereof;
adjusting the pH of the starch in dry powder form to about 8.0-10.0 either prior to, simultaneous with or after adding the additive slurry;
spreading a layer of dried filtered solids on a surface; and
heating the dried filtered solids while on the surface to a temperature of about 100° C. to 190° C. to obtain the physically modified starch.

31-37. (canceled)

38. The process of claim 30 wherein after heating the dried filtered solids while on the surface to a temperature of about 100° C. to 190° C., the process further comprises washing the dried filtered solids with water to form a slurry, and dewatering the slurry, thereby removing soluble additive from the dried filtered solids.

39. The process of claim 38 wherein the dewatering comprises filtering to produce a cake, the process further comprising drying the cake and grinding the cake to obtain the physically modified starch having reduced amount of soluble additive than without washing and dewatering the slurry.

40-42. (canceled)

43. A process for producing a physically modified flour or starch/flour mixture comprising:
(1) spreading a thin layer of material on a surface, and selected from the group consisting of a flour or flour/starch mixture; and
(2) heating the material at a temperature in the range of 100−190° C. for a period of at least 1 hour, wherein a physically modified flour or starch/flour mixture is produced without additives, dehydration or pH adjustment of the material.

44. The process of claim 43 wherein the physically modified flour or starch/flour mixture is produced without any additive.

45. The process of claim 43 wherein the physically modified flour or starch/flour mixture is produced without dehydration of the material.

46. The process of claim 43 wherein physically modified flour or starch/flour mixture is produced without pH adjustment of the material.

47. The process of claim 43 wherein the flour is whole waxy flour and the starch is a waxy starch.

48-51. (canceled)
